(19) United States
(12) Patent Application Publication
(10) Pub. No.: US 2011/0176031 A1
(43) Pub. Date: Jul. 21, 2011

(54) CAMERA AND METHOD FOR CAPTURING AND PROCESSING PHOTOS IN CAMERA

(75) Inventor: JUN LIU, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/732,381

(22) Filed: Mar. 26, 2010

(30) Foreign Application Priority Data
Jan. 20, 2010 (CN) 201010300467.X

(51) Int. Cl. H04N 5/235; G09G 5/00

(52) U.S. Cl. 348/229.1; 345/629; 348/E05.034

(57) ABSTRACT

A camera includes a configuration module, a capture module and a photo composition module. The configuration module stores a standard exposure value (EV), an over-EV and an under-EV. The over-EV is larger than the standard EV, and the under-EV is smaller than the standard EV. The capture module can capture a standard-exposed photo from a first captured view according to the standard EV, capture an over-exposed photo from a second captured view according to the over-EV, and capture an under-exposed photo from third captured view according to the under-EV. The first, second, and third captured views are at a same approximate position. The photo composition module can merge the standard-exposed photo, the over-exposed photo and the under-exposed photo to obtain a final photo.

### BACKGROUND

1. Technical Field

The present disclosure relates to cameras and methods for capturing and processing photos in cameras, especially to a camera and a method to capture a photo in various backlighting conditions.

2. Description of Related Art

In photography, lighting instruments including the sun, may cause some areas of the photo to glow, while the other areas are dark. The user can manually adjust the exposure value of the photo by changing the setting before the photo is captured. However, the photo has only one exposure value when captured, thus some portions of the captured photo may glow or be dark due to the high brightness of the lighting instruments.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a camera in accordance with an embodiment.

FIG. 2 is a schematic view of an exposure value (EV) adjusting window.

FIG. 3 is a schematic view of a standard-exposed photo, an over-exposed photo and an under-exposed photo.

FIG. 4 is a flow chart of an embodiment of a method for capturing and processing photos in the camera.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

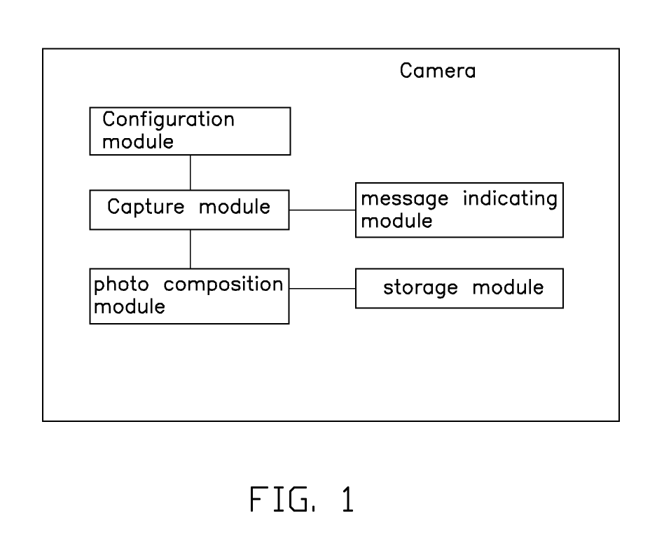

FIG. 1 illustrates a block diagram of a camera in accordance with an embodiment. The camera includes a capture module, a photo composition module, a configuration module, a message indicating module and a storage module. The configuration module, the capture module and the photo composition module connect in sequence. The message indicating module connects to the capture module. The storage module connects to the photo composition module.

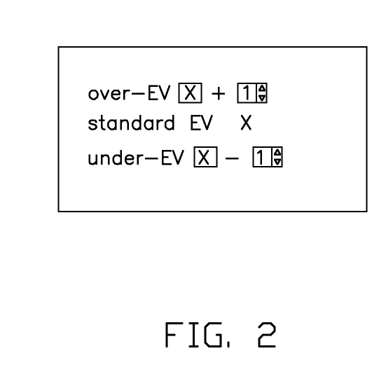

The configuration module stores a standard exposure value (EV), an over-EV and a under-EV. The over-EV is larger than the standard EV, and the under-EV is smaller than the standard EV. In photography, EV denotes all combinations of camera exposure time and a relative aperture that gives the same exposure. The exposure time determines the amount of motion blur, and the relative aperture determines the depth of field. The standard EV, the over-EV and the under-EV can be adjusted by inputting values directly through the configuration module. Referring to FIG. 2, in another embodiment, values relative to the standard EV can be inputted to set the over-EV and the under-EV through the configuration module.

The capture module can capture a standard-exposed photo from a first captured view of the camera according to the standard EV, capture an over-exposed photo from a second captured view according to the over-EV, and capture a under-exposed photo from a third captured view according to the under-EV. The first, second, and third captured views are at a same approximate position. The standard-exposed photo, the over-exposed photo and the under-exposed photo can be obtained in many ways. In one embodiment, the photos can be obtained by pressing the shutter continuously, for example, by pressing the shutter three times within about 3 seconds.

The message indicating module displays a message in the camera after the standard-exposed photo, the over-exposed photo and the under-exposed photo are captured, so that the user can release the camera from a capturing state.

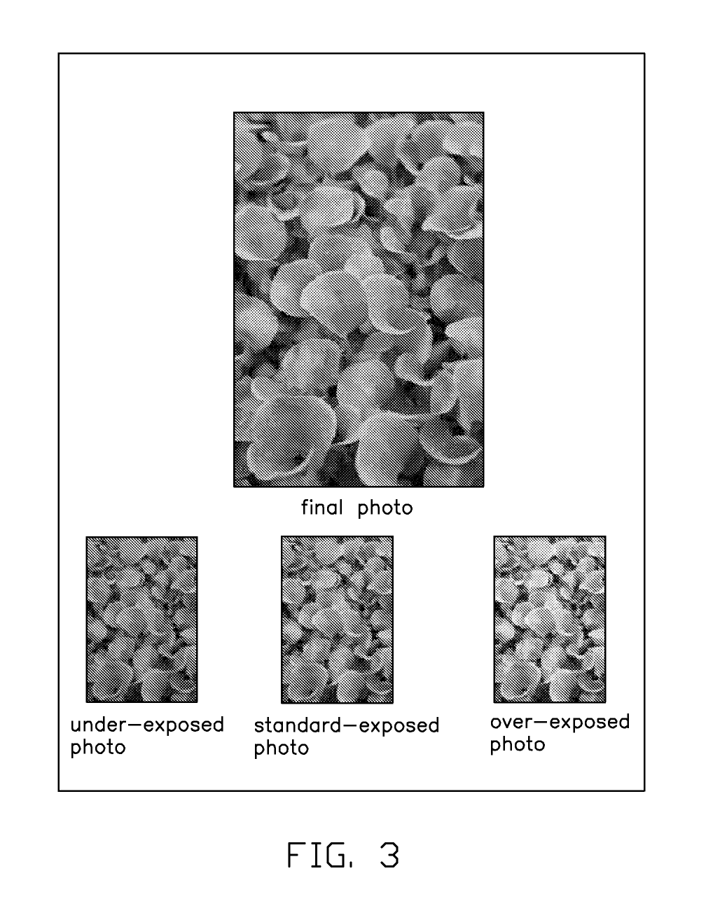

The composition module can merge the standard-exposed photo, the over-exposed photo and the under-exposed photo to a final photo. FIG. 3 illustrates an example of the standard-exposed photo, the over-exposed photo, the under-exposed photo and the final photo. Each of the standard-exposed photo, the over-exposed photo and the under-exposed photo may include a darker area, a normal brightness area and a brighter area. The final photo may include a normal brightness area in standard-exposed photo, a darker area in the over-exposed photo and a brighter area in the under-exposed photo.

The storage module stores the final photo.

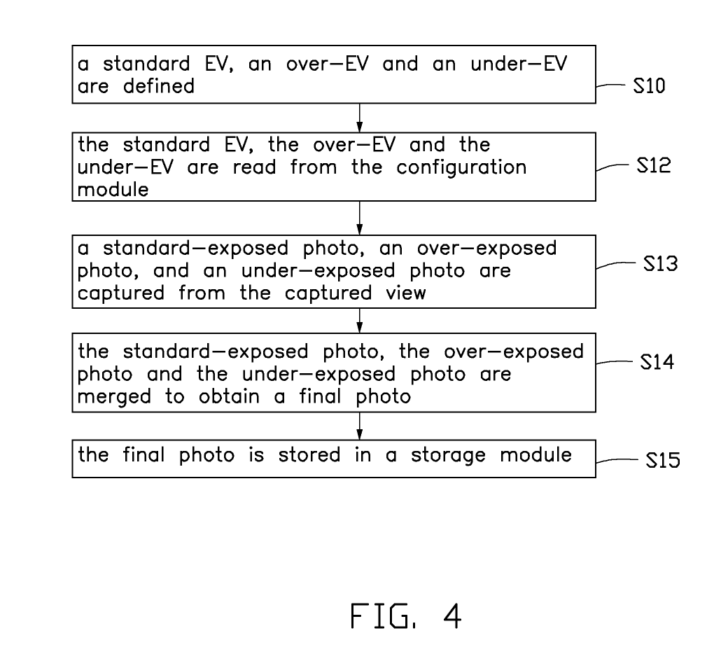

FIG. 4 illustrates a flow chart of a method for capturing and processing photos in the camera, in accordance with one embodiment.

In block S10, a standard EV is defined through the configuration module, and an over-EV and an under-EV are defined by adjusting their values, for example, a value relative to the standard EV.

In block S12, the standard EV, the over-EV and the under-EV are read from the configuration module.

In block S13, a standard-exposed photo is captured from the captured view according to the standard EV, an over-exposed photo is captured from a captured view according to the over-EV, and an under-exposed photo is captured from the captured view according to the under-EV.

In block S14, the standard-exposed photo, the over-exposed photo and the under-exposed photo are merged to obtain a final photo.

In block S15, the final photo is stored in a storage module.

Depending on the embodiment, certain steps of the methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is also to be understood, however, that even though numerous characteristics and advantages have been set forth in the foregoing description of the embodiments, together with details of the structures and functions of the embodiments. The disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method for capturing and processing photos in a camera, the method comprising:
reading a standard exposure value (EV), an over-EV and an under-EV from the camera, wherein the over-EV is larger than the standard EV, and the under-EV is smaller than the standard EV;
capturing a standard-exposed photo from a first captured view of the camera according to the standard EV, capturing an over-exposed photo from a second captured view of the camera according to the over-EV, and capturing a under-exposed photo from a third captured view of the camera according to the under-EV, wherein the first, second, and third captured views are at a same approximate position; and
merging the standard-exposed photo, the over-exposed photo and the under-exposed photo to obtain a final photo.

2. The method of claim 1, wherein the standard-exposed photo, the over-exposed photo and the under-exposed photo are obtained by pressing a shutter continuously.

3. The method of claim 1, wherein before reading the standard exposure value (EV), the over-EV and the under-EV in the camera, the over-EV and the under-EV are defined by adjusting a value relative to the standard EV.

4. The method of claim 1, wherein the final photo comprises a normal brightness area in standard-exposed photo, a darker area in the over-exposed photo and a brighter area in the under-exposed photo.

5. The method of claim 1 further comprising displaying a message in the camera after the standard-exposed photo, the over-exposed photo and the under-exposed photo are captured.

6. The method of claim 1 further comprising storing the final photo to a storage module in the camera.

7. A camera comprising:
a configuration module storing a standard exposure value (EV), an over-EV and an under-EV, wherein the over-EV is larger than the standard EV, and the under-EV is smaller than the standard EV;
a capture module capturing a standard-exposed photo from a first captured view of the camera according to the standard EV, capturing an over-exposed photo from a second captured view of the camera according to the over-EV, and capturing an under-exposed photo from a third captured view of the camera according to the under-EV, wherein the first, second, and third captured views are at a same approximate position; and
a photo composition module merging the standard-exposed photo, the over-exposed photo and the under-exposed photo to obtain a final photo.

8. The camera of claim 7, wherein the standard-exposed photo, the over-exposed photo and the under-exposed photo are obtained by pressing a shutter continuously.

9. The camera of claim 7, wherein the configuration module adjusts the standard EV.

10. The camera of claim 7, wherein the configuration module adjusts a value relative to the standard EV to receive the over-EV and the under-EV.

11. The camera of claim 7 further comprising a message indicating module displaying a message in the camera after the standard-exposed photo, the over-exposed photo and the under-exposed photo are captured.

12. The camera of claim 7 further comprising a storage module storing the final photo.

13. The camera of claim 7, wherein final photo comprises a normal brightness area in the standard-exposed photo, a darker area in the over-exposed photo and a brighter area in the under-exposed photo.
